(19) United States
(12) Patent Application Publication
(10) Pub. No.: US 2004/0027687 A1
(43) Pub. Date: Feb. 12, 2004

(54) Compact zoom lens barrel and system

(76) Inventors: Wilfried Bittner, Tsing Yi (CN); Ivan Kin-Chun Au-Yeung, Mid-Levels (CN)

Correspondence Address: CONCORD CAMERA CORP., 4000 HOLLYWOOD BLVD, #650N, HOLLYWOOD, FL, 33021, US

(21) Appl. No.: 10/613,180

(22) Filed: Jul. 3, 2003

Related U.S. Application Data
(60) Provisional application No. 60/394,134, filed on Jul. 3, 2002.
(60) Provisional application No. 60/450,508, filed on Feb. 27, 2003.

(51) Int. Cl. G02B 15/14

(52) U.S. Cl. 359/694

(57) ABSTRACT

An image capture device including an economical, simplified and compact zoom lens barrel including a guide rib is provided. The zoom lens barrel includes at least first and second lens groups, therein. The position of the second lens group along the optical axis is determined by a feature of the internal surface of the zoom lens barrel.

### PRIORITY

The present application claims priority from co-pending provisional patent application serial No. 60/394,134, Filed on Jul. 3, 2002, and No. 60/450,508, Filed on Feb. 27, 2003, both entitled COMPACT ZOOM LENS BARREL AND SYSTEM.

### FIELD OF THE INVENTION

The present invention relates to the field of image capture devices, and more particularly, to an image capture device including a compact optical zoom barrel including a guide rib, thus requiring fewer parts than previous zoom lens system.

### BACKGROUND OF THE INVENTION

Image capture devices including optical zoom lenses are known. Many zoom lenses currently available have multiple concentric lens barrels for moving the zoom lens groups relative to each other. Guide grooves and cam grooves passing through the inner barrel(s) control the movement of one or more of the lens groups, while housed in a light tight outer lens barrel.

Japanese publication 2001-311863 to Komatsu describes a variable focal distance lens device which sets an interval between a first lens group and a second lens group using a cylindrical cam ring. The second lens group is brought into contact with the cam surface, and the cam is rotated by a driving mechanism corresponding to the amount and direction of movement of the first lens group. The focal distance between the first lens group and second lens group is regulated according to the distance between the edge of the cam ring in contact with the first lens group and the distal stepped edge of the cam ring. It has additionally been discussed to fix the cylindrical cam ring of Komatsu to the inner surface of the lens barrel, to guide the second lens groups relative to the first lens group. However, the use of the cam ring fixed to the lens barrel still requires an extra part, namely the cam ring.

There is a need for a simple and compact zoom lens barrel designed to control the relative linear movement of the zoom lens groups without using cylindrical cam rings or concentric lens barrels.

### SUMMARY OF THE INVENTION

An image capture device including an economical, simplified and compact zoom lens barrel is provided. The zoom lens barrel includes first and second lens groups, therein. The linear position of the second lens group is determined by a feature of the internal surface of the zoom lens barrel.

Other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood, however, that the invention is not limited to the specific methods and instrumentality's disclosed. In the drawings:

FIG. 1 is a general longitudinal cross-sectional view of one embodiment of an image capture device including a lens barrel in the stowed position according to the present invention.

FIG. 2 is a general longitudinal cross-sectional view of one embodiment of an image capture device including a lens barrel in the extended position according to the present invention.

FIG. 3 is an enlarged partial cross-sectional view of the image capture device of FIG. 2.

FIGS. 4 and 5 are developed views of the inside surface of a zoom lens barrel including a lens guide in contact with engaging pins on the lens frames in accordance with one particular embodiment of the present invention.

FIG. 6 is a front perspective view of the rear lens and retainer in accordance with one particular embodiment of the present invention.

FIG. 7 is a rear perspective view of the rear lens and retainer of FIG. 6.

FIG. 8 is a side perspective view of the rear lens and retainer of FIGS. 6 and 7.

FIG. 9 is a front view of a lens useful with a retainer in accordance with one embodiment of the present invention.

FIG. 10 is an exploded rear perspective view of the rear lens and retainer of FIG. 6.

FIG. 11A is a vertical section view of a lens barrel in the home position in accordance with one embodiment of the present invention.

FIG. 11B is a horizontal section view of a lens barrel in the home position in accordance with one embodiment of the present invention.

FIG. 12A is a vertical section view of a lens barrel in the wide position in accordance with one embodiment of the present invention.

FIG. 12B is a horizontal section view of a lens barrel in the wide position in accordance with one embodiment of the present invention.

FIG. 13A is a vertical section view of a lens barrel in the tele position in accordance with one embodiment of the present invention.

FIG. 13B is a horizontal section view of a lens barrel in the tele position in accordance with one embodiment of the present invention.

FIG. 14A is a section view of a lens barrel in accordance with one embodiment of the present invention.

FIG. 14B is a developed view of the inside surface of a zoom lens barrel of FIG. 14A including a cam track in accordance with one embodiment of the present invention.

FIG. 15 is a cross sectional view of a zoom lens barrel in the home position in accordance with one particular embodiment of the present invention.

### DETAILED DESCRIPTION OF THE PREFERRED EMBODIMENTS

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

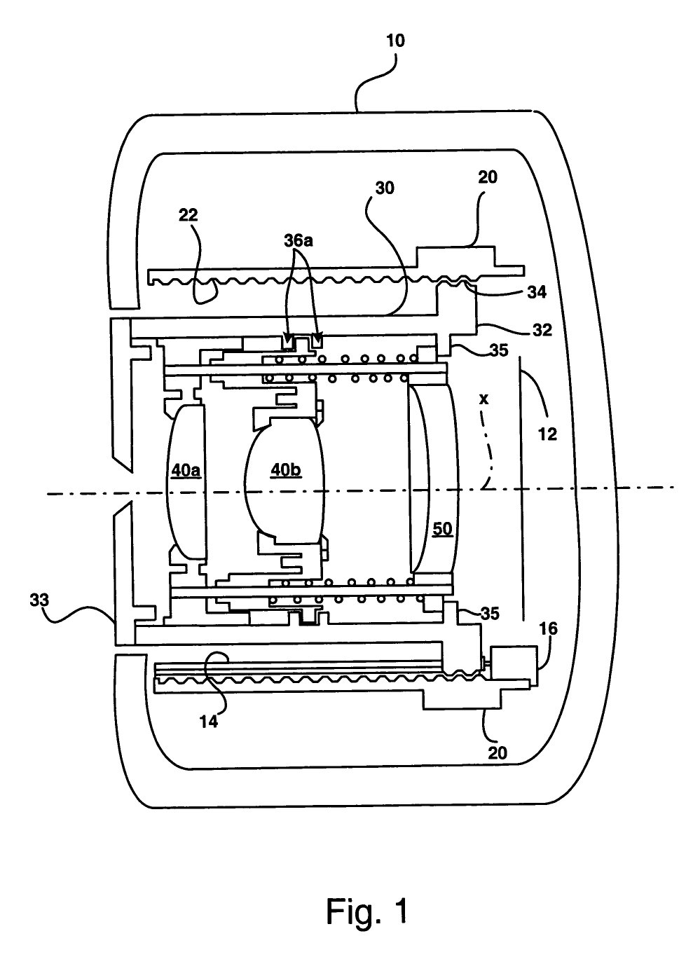

The present invention includes a compact lens barrel design including circumferentially therein a zoom guide rib and a guide track for defining the positions of first and second zoom lens groups during a zoom operation. Referring now to FIGS. 1-3, there is shown an image capture device designated by 10. The image capture device 10 contains a fixed lens box 20 attached to the main camera body (not shown) and centered on the optical axis X, perpendicular to an image capture plane, along which photographing film 12 runs.

Although the present invention will be described in connection with the use of photographing film, this is not meant to be limiting. The zoom lens of the present invention could easily be used in an image capture device that used an image capture sensor in place of photographing film.

The inner surface of the fixed lens box 20 includes helicoids 22 formed thereon. The fixed lens box 20 is fixed in the housing and does not move relative to the optical axis X when the image capture device 10 is in use.

Image capture device 10 additionally includes a zoom lens barrel 30. Zoom lens barrel 30 is sized to engagingly fit circumferentially within the fixed lens box 20. The zoom lens barrel 30 is light tight around the cylindrical surface thereof and is bounded by a retaining ring 32 on the end closest to the photographing film plane 12. The front barrel cover 33 covers the distal end of the zoom lens barrel 30. Front barrel cover 33 includes an aperture therethrough to permit light to pass into the zoom lens barrel 30. Additional lens barrels may be used in combination with zoom lens barrel 30 for greater magnification.

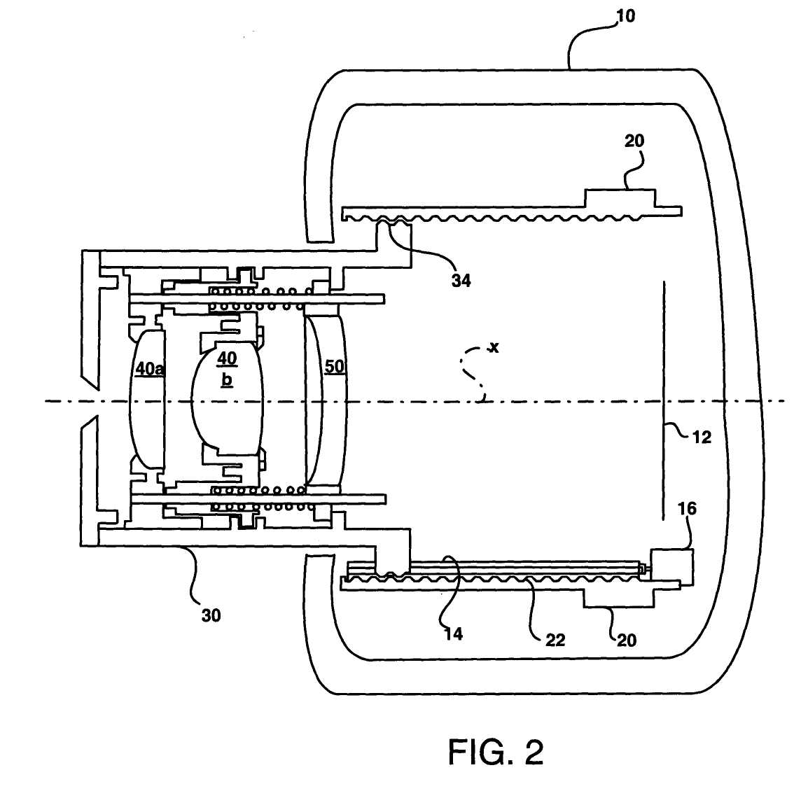

The retaining ring 32 includes helicoids 34 on the surface thereof. Helicoids 34 are designed to slidingly engage helicoids 22 of the fixed lens box 20 to drive the zoom lens barrel 30 and to define the linear travel of the zoom lens barrel 30 in and out of the image capture device between the stored position (shown in FIG. 1) and the extended or zoom position (shown in FIG. 2). Additionally, a portion of the retaining ring 32 includes both helicoids 34 and gear teeth (not shown). The gear teeth interact with a drive gear (not shown) engaged with the drive gear 14 and are used to rotate the zoom lens barrel 30 when the motor 16 is operating.

A shutter mechanism (not shown) is used to block light from reaching the film 12 from the aperture through the front barrel cover 33.

Contained within the zoom lens barrel 30 are at least lenses 40a, 40b and 50. Additional lenses/lens group, not shown, may be included as part of the zoom mechanism. For example, each of the lenses 40a, 40b and 50 may in actuality comprise more than a single lens. In one particular embodiment, the lens 40b is comprised of two distinct lens elements.

Lenses 40a and 40b together form a front lens group of the zoom lens, while lens 50 makes up the rear lens group for the zoom lens. The strength of the zoom lens in magnification is determined by the distance from the lenses 40a, 40b and 50 from the film 12, as well as the spacing between the front lens group (40a, 40b) and the rear lens 50. Focus is adjusted by moving the zoom lens barrel 30 along the optical axis X. The lenses 40a, 40b and 50 are additionally aligned on the optical axis X.

Lenses 40a and 40b are mounted in lens holders 44 and 42, respectively. The lens holders 44 and 42 are fixed relative to each other in the zoom lens barrel 30. Engaging pins 42a and 42b on the body of the lens holder 42 ride within a guide track formed between ribs 36a and ribs 36b, respectively, mounted circumferentially on the inner surface of the zoom lens barrel 30. Lens holder 52, and correspondingly engaging pins 52a and 52b, is biased by compression springs 60 into contact with a zoom guide rib 35 formed on the inner surface of the zoom lens barrel 30. Alternately, the projections 52a and 52b may engage the rear surface of the zoom guide rib 35 (the side furthest from the front lens group 40a, 40b) and a tension spring may be connected between the first and second lens groups to maintain the second lens group projections 52a, 52b biased against the zoom guide rib 35.

As the zoom lens barrel 30 moves linearly outside the body of image capture device 10, the pitch and thread angle of the mated helicoids 22 and 34 causes the zoom lens barrel 30 to rotate a defined amount. Retaining arms (not shown) parallel to the optical axis and part of the front lens group assembly restrict the rotation of the lenses 40a, 40b and 50 about the optical axis, such that they do not rotate with the zoom lens barrel 30.

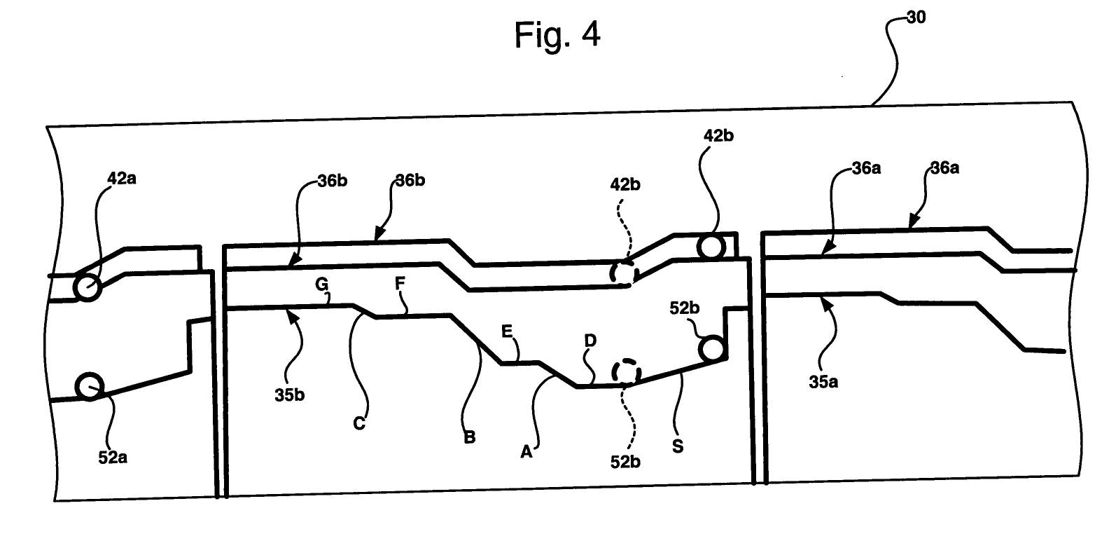

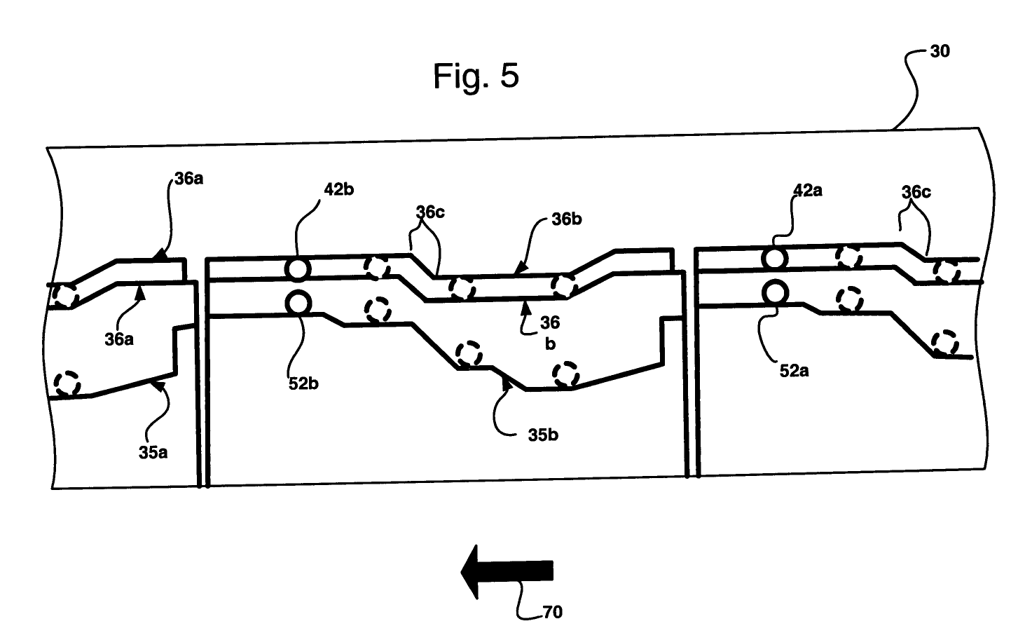

Guide bars 65 pass through the lens holders 42, 44 and 52. The compression springs 60 are mounted circumferentially around the guide bars 65, between the lens holders 42 and 52. As the zoom lens barrel 30 rotates, engaging pins 52a and 52b slideably engage and follow the surface profile of the zoom guide rib 35, as will be further described in connection with FIGS. 4 and 5. Changes in the profile of the zoom guide rib 35 increase and decrease the gap between the lens groups, when the zoom lens barrel 30 is retracted or advanced, respectively. As the zoom lens barrel 30 is advanced during zooming, the distance between the lens groups (40a and 40b; 50) and the film plane 12 increases while the distance between the two lens groups (40a and 40b; 50) decreases. Focusing after zooming is accomplished by increasing the distance between the lens groups (40a and 40b; 50) and the film plane 12, while keeping the distance between the lens groups (40a and 40b; 50) themselves the same. Zoom guide rib 35 is preferably formed as part of the zoom lens barrel 30 simultaneously with the formation of the zoom lens barrel 30. Alternately, the zoom guide rib 35 may be affixed to the zoom lens barrel 30 or formed therein after formation of the zoom lens barrel 30. In one preferred embodiment, except for shoulders 36a, 36b and zoom rib 35, which extend outward from the inner zoom lens barrel surface, the inner circumferential surface of zoom lens barrel 30 is of substantially constant width.

Referring now to FIGS. 4 and 5, there are shown developed views of the inside surface of the zoom lens barrel 30, in accordance with one particular embodiment of the present invention, wherein FIG. 4 corresponds to the position shown in FIG. 1 and FIG. 5 corresponds to the position shown in FIG. 2.

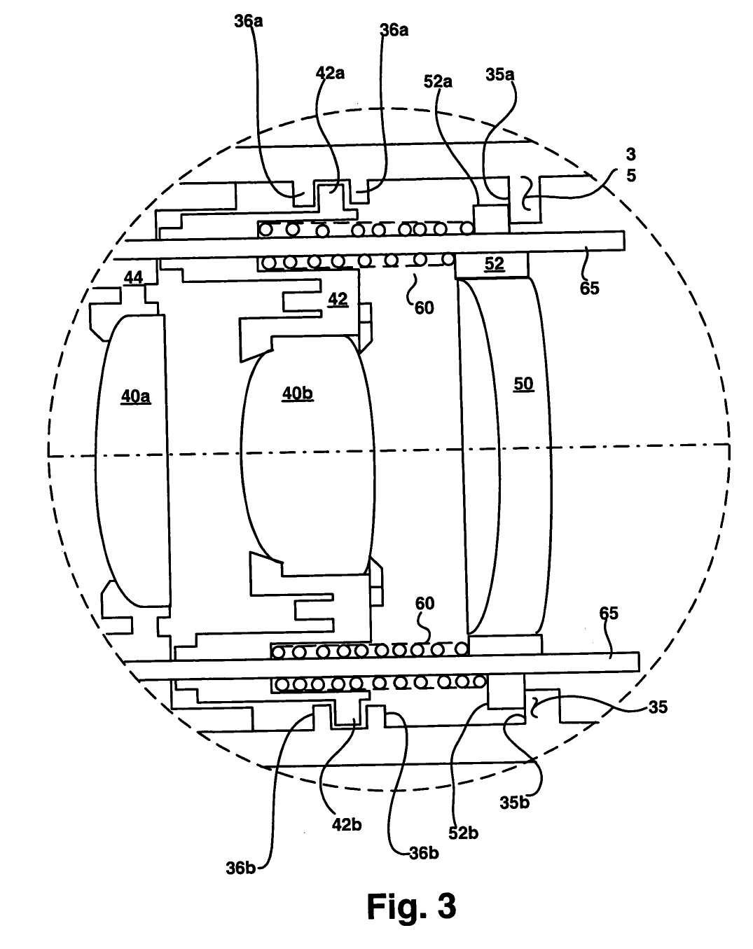

Referring specifically to FIGS. 3, 4 and 5, the inner surface of the zoom lens barrel 30 includes formed thereon two guide section groups designed to interact with engaging pins 42a, 42b; 52a, 52b at the top and bottoms of the lens holders 42 and 52. The first guide section, which is designed to interact with the engaging projections 42a of the lens holder 42 and 52a of the rear lens holder 52, comprises the zoom guide rib 35a and the guide track formed between the shoulders 36a. To provide symmetry and stability for both the upper and lower portions of the lens holders, a second guide section is designed to interact with the engaging projections 42b and 52b, includes the zoom guide rib 35b and the guide track formed by the shoulders 36b.

In the specific embodiment shown in FIGS. 4 and 5, the zoom guide rib 35 is stepped and includes zooming sloped portions A, B and C, focusing plateaus D, E, F and G and storage section S.

Engaging pins 52a, 52b of the rear lens holder 52 are spring biased against the ribs 35a, 35b, respectively. As the zoom lens barrel 30 rotates axially around the optical axis (X of FIGS. 1 and 2), the rear lens group moves linearly forward or back within the zoom lens barrel 30, based on the direction of rotation of the lens barrel and the contour of the profile of the rib 35. When the zoom lens barrel 30 rotates in the direction of arrow 70 (FIG. 5), depending on the amount of rotation, the engaging pins 52b (shown in shadow in FIG. 5) are moved up the slope(s) A, B and/or C to zoom, and are moved along the plateaus D, E, F or G to focus. While the engaging pins 52a and 52b are on the plateaus D, E, F and G, the zoom lens barrel 30 continues to rotate and to move linearly outside the image capture device 10. This focuses the image by increasing the distance between the lens groups and the film plane 12 by further extending the zoom lens barrel 30, and correspondingly, the lenses 40a, 40b and 50, without changing the relative positions between the lenses 40a, 40b, 50.

As lens barrel 30 rotates, the engaging pins 42a and 42b travel in the guide tracks formed by shoulders 36a and 36b, respectively (as shown in shadow in FIG. 5). Note that in the present specific embodiment, the guide track formed by the shoulders 36a and 36b are additionally sloped at 36c to move the front lens holders 42 and 44 (which have a fixed relative spacing therebetween) closer to the lens barrel cover 33 and provide more room inside the zoom lens barrel 30 for the zooming operation of the rear lens 50.

Referring now to FIGS. 1-5, in operation, initially, when the image capture device is turned on, a motor 16 and drive gear 14 drive the zoom lens barrel 30 outside the image capture device, from the stored position (42b and 52b shown in solid in FIG. 4) to an initial or wide angle position (42b and 52b shown in shadow in FIG. 4). As the lens barrel moves from the wide angle position to the full zoom extended position (FIGS. 2, 3 and 5), the rear lens group 50 is moved by the slopes A, B and/or C closer to the front lens group 40a and 40b, while both lens groups move further away from the film plane 12 as a result of the linear extension of the zoom lens barrel 30. Zooming occurs when the lens 50 is forced linearly forward along the optical axis X by the sloped portions A, B and C. Focusing is preset such that rotation of the zoom lens barrel 30 is stopped at predetermined positions during extension of the zoom lens barrel 30, while engaging pins 52a and 52b are in contact with one of the plateau portions D, E, F or G.

Note that the lens holders 42 and 52 are fixed rotationally relative to each other, such that when the zoom lens barrel 30 rotates the lenses themselves do not rotate, they only move linearly. To store the zoom lens barrel 30 within the image capture device, the motor 16 is run in reverse and the zoom lens barrel 30 is retracted into the image capture device 10 with the lenses 40a, 40b and 50 stored as shown in FIGS. 1 and 4.

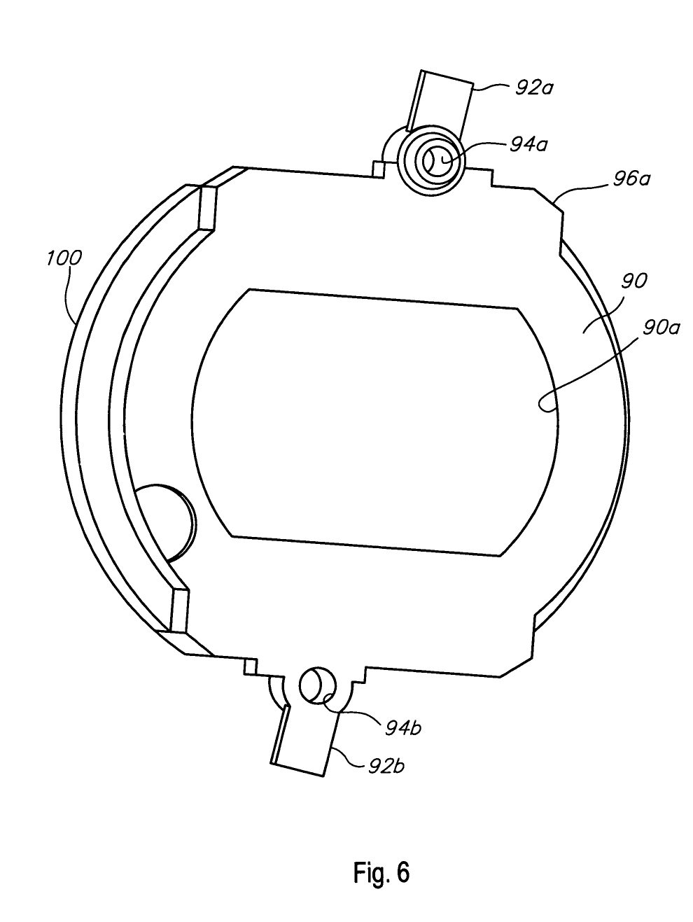

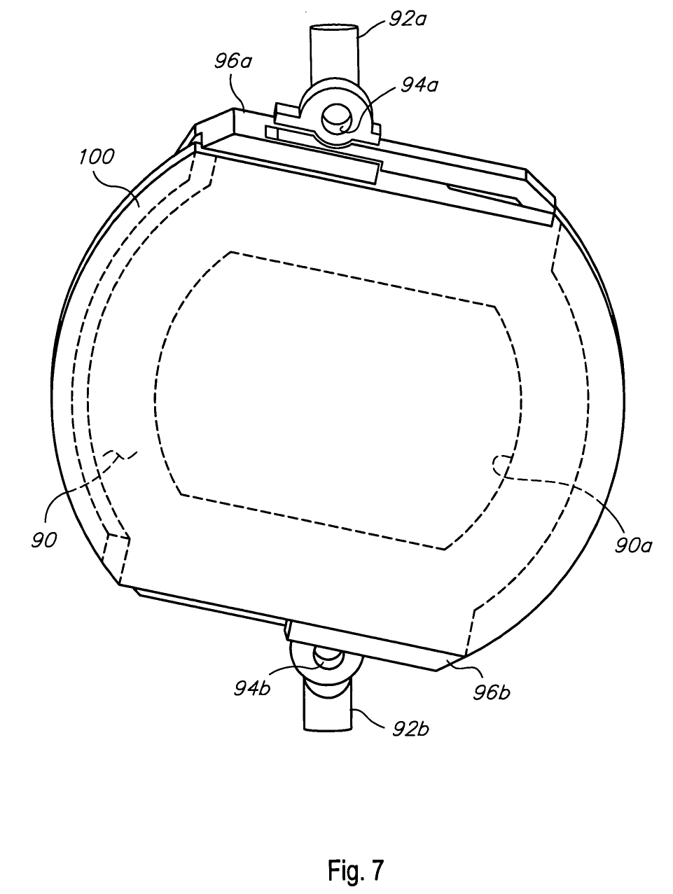

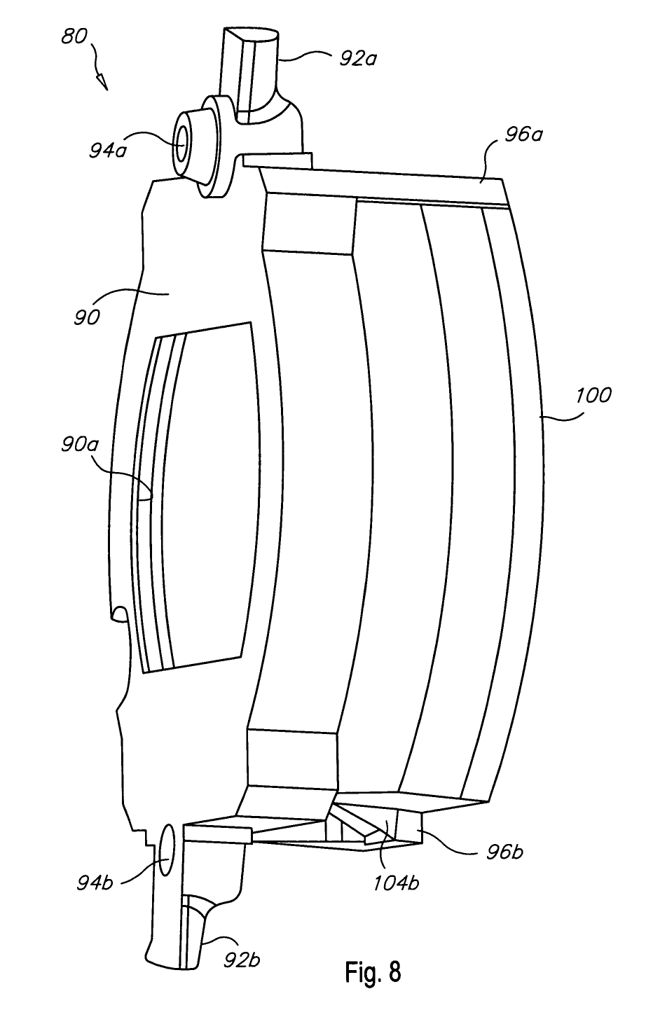

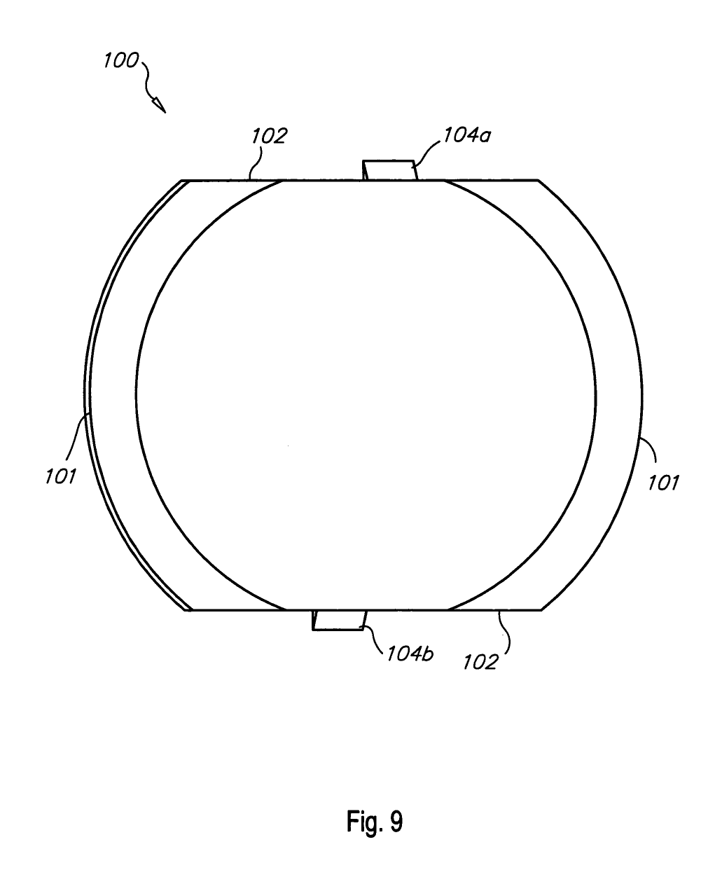

Referring now to FIGS. 6-10, there is shown a lens 100 and retainer 90 combination 80 useful with a zoom lens system as described in connection with FIGS. 1-5. If desired, the lens and retainer combination 80 may be used in place of the rear lens holder 52 and lens 50 of FIGS. 1 and 2.

The lens 100 has two generally circular arcuate portions 101 bounded by two planar portions 102. Present on the surface of each planar portion is a generally wedge-shaped lug 104a and 104b. Lugs 104a and 104b are slightly offset from each other and are designed to lockingly engage arms 96a and 96b, respectively, on the lens retainer 90. Retainer 90 includes an aperture 90a through the center thereof, through which light passes. Additionally retaining arms 96a and 96b initially extend outward parallel to the optical axis X and curve around such that they are open in opposing directions and extend perpendicular to the optical axis X. The lens 100 slides into the retainer 90 such that the planar portions 102 are adjacent the arms 96a and 96b, and a flat face on the arms 96a and 96b engage the flat faces of the wedge-shaped lugs 104a and 104b to hold the lens 100 in the retainer 90 in the proper optical alignment. Note that in the present embodiment, retaining arms (not shown) extending rearward from the front lens group holder (or, alternately, extending forward from a rear lens mask or guide) engage the upper and lower flat portions of the retainer 90 adjacent the arms 96a and 96b to prevent the lens and retainer combination 80 from rotating with the lens barrel (30 of FIGS. 1 and 2).

Retainer 90 additionally includes engaging pins 92a and 92b. Engaging pins 92a and 92b in the present embodiment are offset at an angle to permit engagement between each engaging pin 92a, 92b and the appropriate zoom guide ribs (35a, 35b of FIGS. 4 and 5). However, it is clear that this is only a matter of design. The engaging pins may be differently positioned and/or a greater number of engaging pins and corresponding zoom guide ribs may be added, if desired, so long as the engaging pins engage a zoom guide rib at appropriate locations during the zooming operation.

In the present embodiment, the engaging pins 92a and 92b are semicircular, having a rounded face designed to engage the zoom guide rib (35a, 35b of FIGS. 4 and 5) with a minimum of friction to permit the engaging pin to slide along the zoom guide ribs. The particular geometric shape of the opposite face of the engaging pins 92a, 92b is not important. In the present particular embodiment, the opposite face of the engaging pins 92a, 92b are flat.

The retainer 90 includes two bores 94a and 94b therethrough. Each bore 94a and 94b is proximal to and aligned with an engaging pin 92a, 92b and is sized to receive a guide pin (65 of FIG. 3) therethrough. With each guide pin passed through the retainer 90 proximal to the engaging pins 92a, 92b, the compression spring (60 of FIG. 3) applies a direct force at the location of the engaging pins 92a, 92b to maintain them against the zoom guide rib (35a, 35b of FIGS. 4 and 5). If desired, a frusto-conical projection may extend around the bore(s) 94a and/or 94b to engage and center the compression spring (60 of FIG. 3).

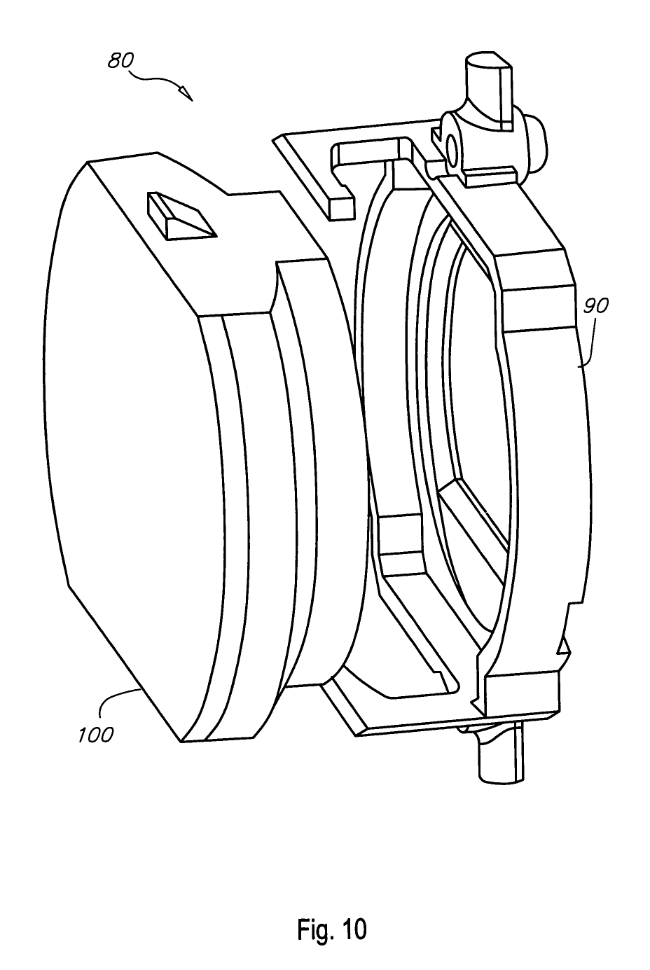

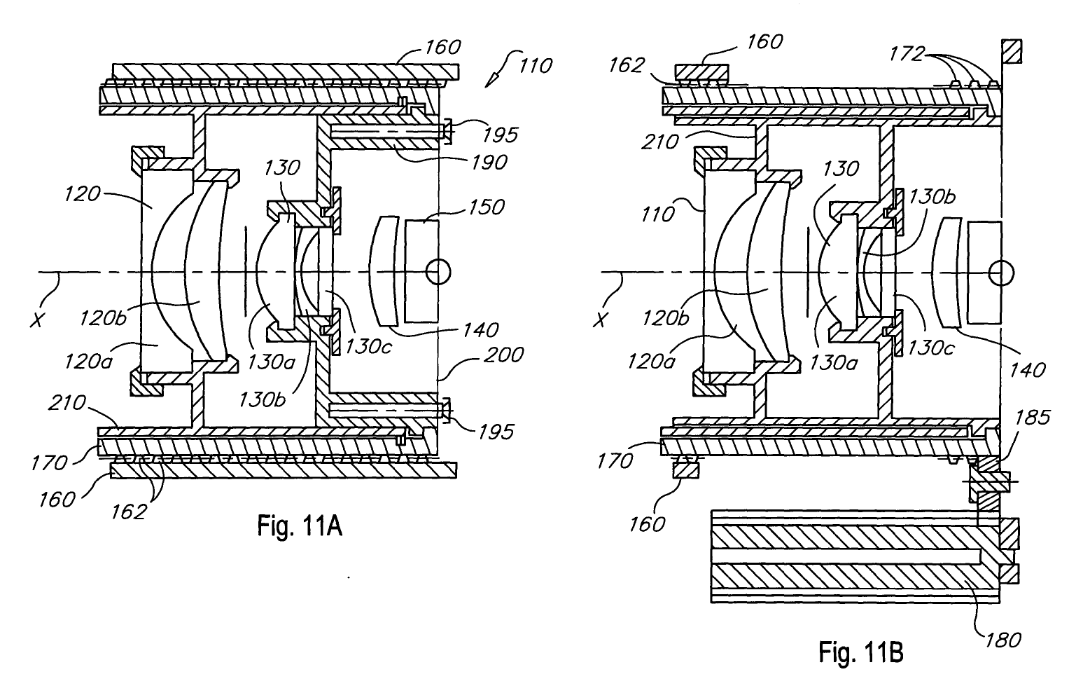

Referring now to FIGS. 11A-13B there is shown another embodiment of the zoom lens barrel of the present invention. The zoom lens barrel 110 is similar to embodiment described in connection with FIG. 1, wherein the distance between a front group 120 and a rear group 130 is changed to effectuate the zoom. The zoom lens 110 of the present particular embodiment additionally includes a separate focusing lens 140. An optical axis X passes through the front and rear lens groups 120, 130 and the focusing group 140. In the present particular embodiment, a filter 150 is disposed over a digital image sensor, such as a CMOS or CCD image sensor, in line with the lens groups 120, 130, 140 on the optical axis X, the surface of which sensor defines an image capture plane.

Depending on the lens formulas and lens materials, the front lens group 120, rear lens group 130 and focusing group 140, may each consist of a single lens or a plurality of lenses, such as lenses 120a and 120b, 130a, 130b and 130c and 140, respectively. The lens groups 120, 130 and 140 are housed in an image capture device, housing, such as image capture device 10 of FIG. 1. Fixed within the image capture device housing is a fixed lens box 160 having helicoids 162 formed on the inner surface thereof. The fixed lens box 160 is stationary within the image capture device.

Engaged with the fixed lens box 160 is a first lens barrel 170. First lens barrel 170 includes helicoids 172 on the outer surface thereof. The first lens barrel is driven by a DC motor (not shown) through a chain of spur gears, including spur gears 180 and 185. Spur gear 180 is the gear that connects to the DC motor, while spur gear 185 engages the spur gear 180 to the first lens barrel 170. As the DC motor rotates the spur gears 180, 185, and correspondingly the first lens barrel 170 additionally rotates and is forced to move forward or back along the optical axis X by the engagement of the helicoids 172 with the helicoids 162 of the fixed lens box 160.

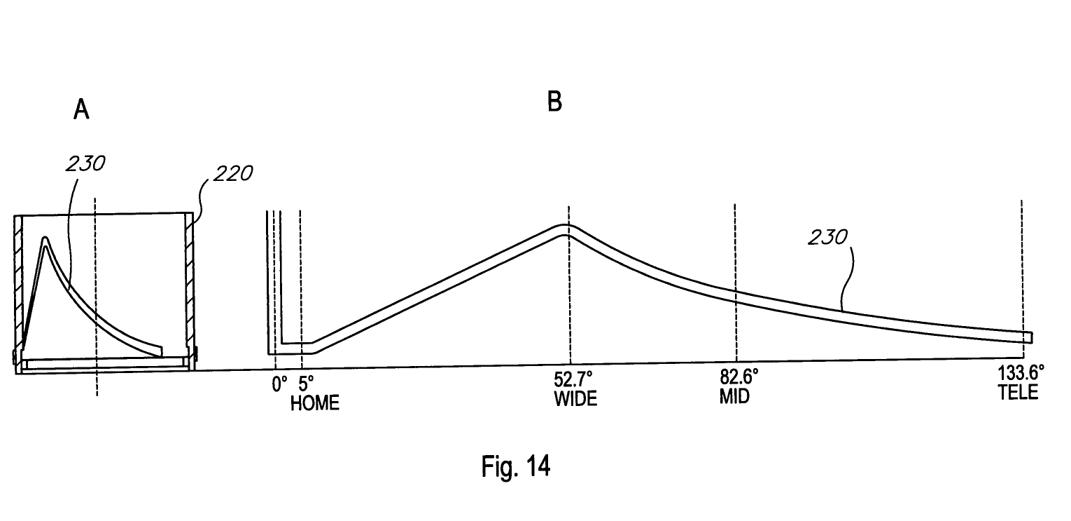

In the present embodiment, unlike the embodiment described in connection with FIG. 1, the rear lens group 130 does not move within the first lens barrel. Rather, the rear lens group 130 is set in a lens holder 190, which is fixed to the first lens barrel 170. The lens holder 190 may be fixed to the first lens barrel using any known means. In the present embodiment screws 195 are used. As such, the rear lens group 130 is moved by the first lens barrel 170. The rear lens group holder is prevented from rotating by a rear plate 200, which has a key that fits in a slot of the fixed lens box 160, thus permitting the holder 190 to slide forward or back along the optical axis X, with the first lens barrel 170. The inner surface of the first lens barrel 170 additionally includes a cam track thereon, such as cam track 36 of FIG. 4 or 230 of FIG. 14.

The front lens group 120 is housed in a lens holder 210, that is its self, shaped like a lens barrel. One end of the lens holder 210 is engaged in the cam track of the first lens barrel 170. As such, the lens holder 210, and correspondingly, the front lens group 120, is moved by the cam on the inner surface of the first lens barrel 170.

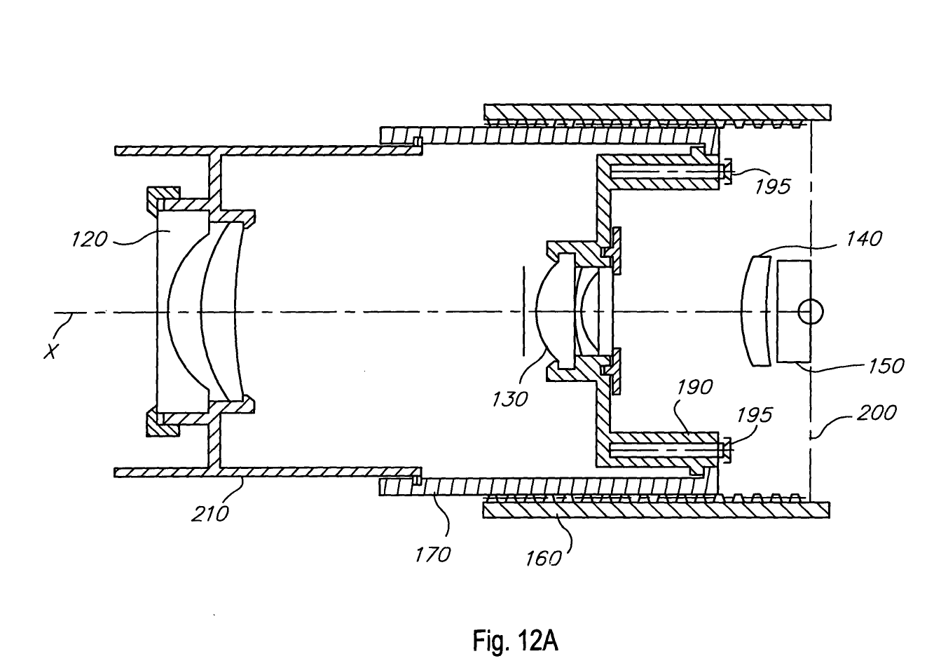

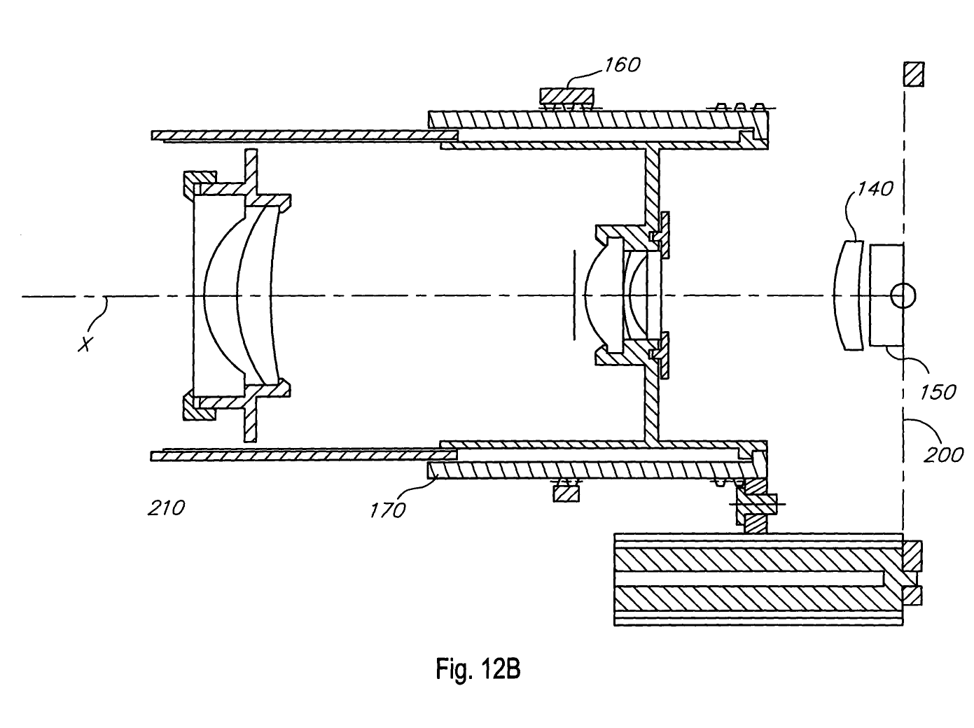

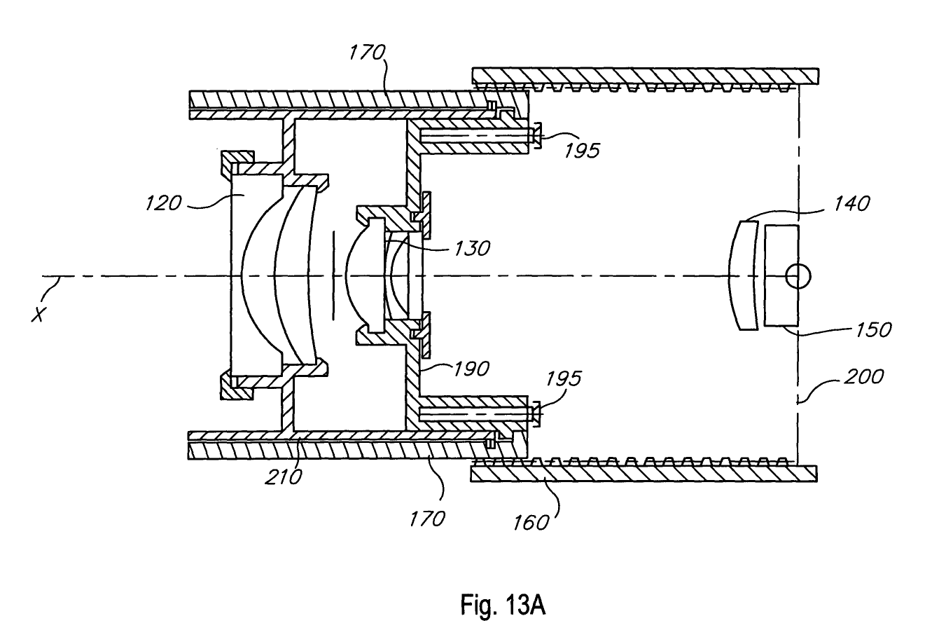

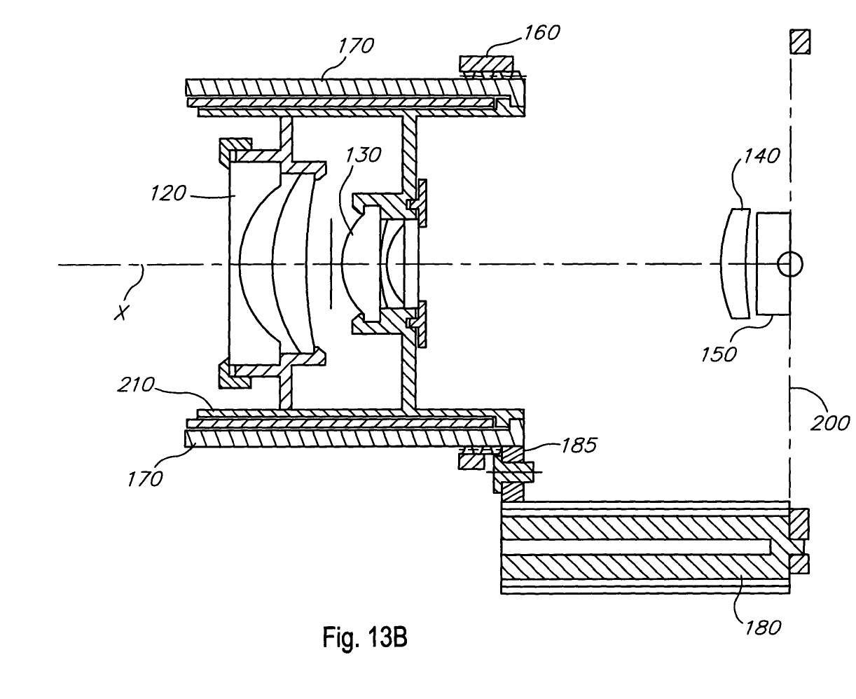

FIGS. 11A and 11B show the vertical and horizontal section views, respectively, of the zoom lens in the home or stored position. Both the lens holder 210 and the first lens barrel 170 are compactly stored within the fixed lens box 160. In FIGS. 12A and 12B, the lens barrel 110 is shown in the wide position, wherein the rear lens group 130 is moved forward on helicoids 162, but is still close to the focusing lens and image sensor and the front lens group 120 is extended outward from the first lens barrel 170 on the cam track (not shown). In FIGS. 13A and 13B, the lens barrel is shown in the tele position, wherein the first lens barrel is moved further forward along the helicoids 162, nearly to the end of the fixed lens box 160. In this position, the lens holder 210 of the front lens group 120 has traveled along the cam track in the inner surface of the first lens barrel 170 to affect a predetermined distance relationship with the rear lens group 130 carried by the first lens barrel 170. The lens holder 210 may additionally be spring biased relative to the rear lens group 130, to more easily facilitate the return of the lens holder 210 to the home position.

Referring now to FIG. 14, there is shown in 14A, a cross section of a lens barrel 220 that may be used as the first lens barrel 170 in the embodiment of FIGS. 11A-13B. The lens barrel 220 includes formed thereon a cam track 230, which does not pass through the outer wall of the lens barrel 220. In FIG. 14B, there is shown a developed view of the inner surface of the lens barrel 220 showing the cam track 230. As can be seen, the cam track 230 is preset in shape to permit the front lens holder (such as 210 of FIGS. 11A-13B) travel to the positions necessary for the stored, wide and tele positions at distances relative to the fixed rear lens group (130 of FIGS. 11A-13B). The principle of the present embodiment is very similar to that discussed above in connection with FIGS. 4 and 5, wherein the front lens group moves linearly along the optical axis to predetermined positions based on the shape of the cam track 230 when the lens barrel 220 is rotated.

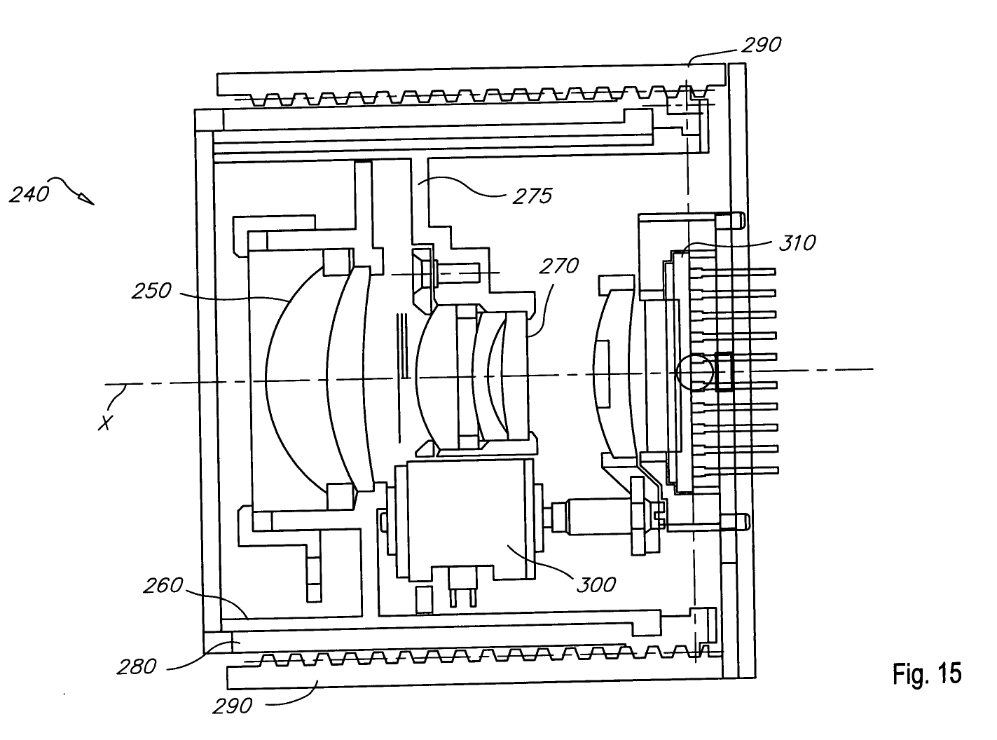

Referring now to FIG. 15, there is shown a cross sectional view of a lens barrel 240 in accordance with one particular embodiment of the present invention. The lens barrel 240 is similar in many respects to that shown in connection with FIGS. 11A-13B. A front lens group 250 is mounted in a holder 260. A rear lens group 270 is mounted in a holder 275 fixed to the lens barrel 280. The front lens group holder 260 is engaged with a cam groove, such as 230 of FIG. 14, located on the inner surface of the lens barrel 280. The lens barrel 280 is engaged using mating helicoids with a fixed lens box 290 located within the image capture device. Additionally, a focusing motor 300 is located within the lens barrel 280 in order to step the focusing lens during an autofocus operation. In the present embodiment, autofocusing is controlled by an algorithm that steps the focusing lens through a predetermined number of steps while testing the image on the image sensor 310. The stepping motor is returned to the position where the image on the sensor returned the best contrast or focused image. Additionally, if desired, a shutter may be mounted to the holder 275 of the rear lens group 270. Upon actuation of an image capture trigger button, a shutter may close and the image present at the sensor at that time may be processed by an image processor (not shown) and stored for later retrieval.

The lens barrel and lens holders of the present invention may be made from the same material or, from different materials. In the preferred embodiment, the lens barrel and zoom guide rib are integrally formed of a polymeric material such as plastic. However, it can be seen that the lens barrel and/or lens holders may be machined or extruded from metal or other materials and the zoom guide rib machined or otherwise formed or affixed thereto. Additionally, although particular embodiments have been described in connection with film or in connection with an image sensor, it should be understood that any embodiment described herein would be equally applicable to use in a film camera or in a digital camera, without regard to whether film or an image sensor is described in the particular embodiment.

While the invention has been described with reference to a preferred embodiment, it will be understood by those skilled in the art that various changes may be made and equivalents may be substituted for elements thereof without departing from the scope of the invention. Additionally, it can be seen that fewer or greater number of lens barrels may be used and still remain within the scope of the present invention. Further, where the zoom guide rib is described as having four steps, greater or fewer steps may be provided to increase the discrete number of magnification steps of the lens system without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A zoom lens system, comprising:
a lens barrel having a light tight circumferential outer surface, said lens barrel including a zoom guide rib on the inner circumferential surface of said lens barrel proximal to an image capture plane;
a first lens group located in said lens barrel distal from said image capture plane;
a second lens group, moveable independent of said first lens group, said second lens group slideably engaging said zoom guide rib;
a bias member to engage said second lens group with said zoom guide rib during movement of said lens barrel; and
wherein the profile of said zoom guide rib is designed to move said second lens group linearly along an optical axis relative to said first lens group upon rotation of said lens barrel.

2. The zoom lens system of claim 1, wherein the profile of said zoom guide rib is contoured in steps.

3. The zoom lens system of claim 2, wherein the profile of said zoom guide rib provides for at least four discrete zoom lens step positions.

4. The zoom lens system of claim 1, wherein said lens barrel additionally comprising a pair of guide track shoulders on the inner circumferential surface thereof, said pair of guide track shoulders forming a guide track therebetween distal from said film end, and wherein a portion of said first lens group rides in said guide track.

5. The zoom lens system of claim 4, wherein the profile of said zoom guide rib is contoured in steps and wherein said guide track includes a stepped portion coordinated with at least one of said zoom guide rib steps.

6. The zoom lens system of claim 1, wherein said bias member includes a spring.

7. The zoom lens system of claim 6, wherein said spring is located between said first lens group and said second lens group, wherein, said spring maintains said second lens group biased against said zoom guide rib, based on the position of said first lens group.

8. The zoom lens system of claim 7, wherein said spring is a compression spring and wherein said second lens group is biased against a front face of said zoom guide rib distal from said image capture plane.

9. The zoom lens system of claim 7, further including a guide pin connected between and passing through said first lens group and said second lens group, said spring being located concentrically around said guide pin between said first lens group and said second lens group.

10. An image capture device, comprising:
an image capture device housing;
a lens box fixed within said image capture device housing, said lens box including a plurality of helicoids located on the inner surface thereof;
a zoom lens, a portion of which is located circumferentially within said lens box, said zoom lens including,
a lens barrel having a light tight circumferential outer surface including lens barrel helicoids on a portion thereof to mate with said lens box helicoids, said lens barrel additionally including a zoom guide rib on the inner circumferential surface of said lens barrel proximal to an image capture plane, wherein the profile of said zoom guide rib is designed to move a second lens group linearly along an optical axis relative to a first lens group upon rotation of said lens barrel;
a first lens group located in said lens barrel;
a second lens group, moveable independent of said first lens group, said second lens group slideably engaging said zoom guide rib;
a bias member to engage said second lens group with said zoom guide rib during movement of said lens barrel;
a drive train including a motor, said drive train engaged with said lens barrel to rotate said lens barrel axially and to drive said lens barrel linearly out side said housing; and
wherein rotation of said lens barrel by said drive train causes at least a portion of said second lens group to follow said zoom guide rib to move said second lens group linearly within said lens barrel.

11. The zoom lens system of claim 10, wherein the profile of said zoom guide rib is contoured in steps.

12. The zoom lens system of claim 11, wherein the profile of said zoom guide rib provides for at least four discrete zoom lens step positions.

13. The zoom lens system of claim 10, wherein said lens barrel additionally comprising a pair of guide track shoulders on the inner circumferential surface thereof, said pair of guide track shoulders forming a guide track therebetween distal from said film end, and wherein a portion of said first lens group rides in said guide track.

14. The zoom lens system of claim 10, wherein said bias member includes a spring.

15. The zoom lens system of claim 14, wherein said spring is located between said first lens group and said second lens group, wherein, said spring maintains said second lens group biased against said zoom guide rib, based on the position of said first lens group.

16. The zoom lens system of claim 15, further including a guide pin connected between and passing through said first lens group and said second lens group, said spring being located concentrically around said guide pin between said first lens group and said second lens group.

17. A lens group for use in a zoom lens system, comprising;
a lens holder, said lens holder including,
a lens holder body including a front face and a rear face, a first planar body edge and a second planer body edge both perpendicular to said front and rear faces, said first and second planar edges being separated on one side by a third edge and on the other side by a fourth edge, said third edge and said fourth edge additionally being perpendicular to said faces, said body further including an aperture therethrough extending from said front face to said rear face;
a first retaining arm extending from said rear surface proximal to said first planar edge and curving around to extend substantially parallel to said rear face;
a second lens retaining arm extending from said rear surface proximal to said second planar edge and distal from said first planar edge, said second retaining arm extending from said rear face and curving around to substantially extend parallel to said rear face;
a first zoom rib engaging projection extending from said first planar edge;
a second zoom rib engaging projection extending from said second planar edge; and
a lens aligned with said aperture through said body, said lens being held in contact with said rear face by said first and second retaining arms.

18. The lens group of claim 17, wherein said first retaining arm extends from said rear face proximal to said third edge and is open to receive said lens proximal to said fourth edge and wherein said second retaining arm extends from said rear face proximal to said fourth edge and is open to receive said lens proximal to said third edge.

19. The lens group of claim 18, wherein said lens includes a first planar lens edge and a second planar lens edge, said first planar lens edge being aligned in said holder with said first planar body edge, said second planar lens edge being aligned with said second planar body edge.

20. The lens group of claim 19, wherein said lens includes a first radial lens edge and a second radial lens edge and wherein said third edge and said fourth edge include radial portions, said first radial lens edge being aligned with said third edge and said second radial lens edge being aligned with said fourth edge.

21. The lens group of claim 19 wherein said first planar lens edge includes a first wedge thereon and said second planar lens edge includes a second wedge thereon, wherein said first wedge engages said first retaining arm and said second wedge engages said second maintaining arm to maintain said lens against said lens holder body.

22. The lens group of claim 21, wherein said first zoom rib engaging projection includes a first guide pin bore therethrough and wherein said second zoom rib engaging projection includes a second guide pin bore therethrough.

23. The lens group of claim 22, wherein at least one of said first and second zoom rib engaging projections includes a frustoconical projection extending therefrom and centered around said guide pin bore.

24. The lens group of claim 23 wherein at least one of said first zoom rib engaging projection and said second zoom rib engaging projection extends from said first planar body edge or said second planar body edge at a non-right angle.

25. A zoom lens system, comprising:
a lens barrel having a light tight circumferential outer surface, said lens barrel including a cam track on the inner circumferential surface of said lens barrel;
a first lens group located in said lens barrel in fixed relation to a first end of said lens barrel proximal to an image capture plane;
a second lens group, moveable independent of said first lens group, said second lens group slideably engaging said cam track; and
wherein the profile of said cam track is designed to move said second lens group linearly along an optical axis relative to said first lens group upon rotation of said lens barrel.
